(19) United States
(12) Patent Application Publication
(10) Pub. No.: US 2025/0337092 A1
(43) Pub. Date: Oct. 30, 2025

(54) BATTERY SYSTEM INCLUDING IMPROVED CELL COVER

(71) Applicant: SAMSUNG SDI CO., LTD., Yongin-si (KR)

(72) Inventor: Florian TRIPAUM, Wolfau (AT)

(21) Appl. No.: 18/813,949

(22) Filed: Aug. 23, 2024

(30) Foreign Application Priority Data
Apr. 26, 2024 (EP) 24172659.5

(51) Int. Cl. H01M 50/342; H01M 50/291; H01M 50/293

(52) U.S. Cl. CPC H01M 50/3425; H01M 50/291; H01M 50/293; H01M 2220/20

(57) ABSTRACT

A battery system includes: a plurality of battery cells, each having a venting exit for discharging a venting gas stream at a venting side thereof; a first cover sheet having a first thickness covering the venting side of the battery cells to protect the battery cells from the venting gas stream discharged from an adjacent one of the battery cells and having venting openings aligned with the venting exits of the battery cells for letting the discharged venting gas stream pass therethrough; and a second cover sheet having a second thickness arranged between the first cover sheet and the plurality of battery cells to cover the venting exits of the battery cells. The second cover sheet being configured to rupture at a section opposite the venting exits due to the discharged venting gas stream exiting the covered venting exit, and the first thickness is larger than the second thickness.

### CROSS-REFERENCE TO RELATED APPLICATION

The present application claims priority to and the benefit of European Patent application Ser. No. 24/172,659.5, filed on Apr. 26, 2024, in the European Patent Office, the entire disclosure of which is incorporated herein by reference.

### BACKGROUND

### 1. Field

Aspects of embodiments of the present disclosure relate to a battery system.

### 2. Description of the Related Art

Recently, vehicles for transportation of goods and peoples have been developed that use electric power as a source for motion. Such an electric vehicle is an automobile that is propelled, permanently or temporarily, by an electric motor using energy stored in rechargeable batteries. An electric vehicle may be solely powered by batteries (a so-called Battery Electric Vehicle “BEV”) or may include a combination of an electric motor and, for example, a conventional combustion engine (a so-called Plugin Hybrid Electric Vehicle “PHEV”). BEVs and PHEVs use high-capacity rechargeable batteries, which are designed to provide power for propulsion for sustained periods of time.

Generally, a rechargeable (or secondary) battery cell includes an electrode assembly including a positive electrode, a negative electrode, and a separator interposed between the electrodes. A solid or liquid electrolyte allows for movement of ions during charging and discharging of the battery cell. The electrode assembly is located in (e.g., is accommodated in) a casing, and electrode terminals, which are positioned on the outside of the casing, establish an electrically conductive connection to the electrodes. The casing may have, for example, a cylindrical or rectangular shape.

A battery module is formed of a plurality of battery cells connected together in series or in parallel. For example, the battery module is formed by interconnecting the electrode terminals of the plurality of battery cells, in a number and configuration depending on a desired amount of power, to provide a high-power rechargeable battery.

Battery modules can be constructed in either a block design or in a modular design. In the block design, each battery cell is coupled to a common current collector structure and a common battery management system, and the unit thereof is arranged in a housing. In the modular design, pluralities of battery cells are connected together to form submodules, and several submodules are connected together to form the battery module. In automotive applications, battery systems generally include a plurality of battery modules connected together in series to provide a desired voltage.

A battery pack is a set of any number of (usually identical) battery modules or single battery cells. The battery modules, or respectively the battery cells, may be configured in a series, parallel, or a mixture of both to provide the desired voltage, capacity, and/or power density. Components of a battery pack include the individual battery modules and interconnects, which provide electrical conductivity between the battery modules.

An active or passive thermal management system may be included to provide thermal control of the battery pack and to ensure safe use the battery module by efficiently emitting, discharging, and/or dissipating heat generated from its rechargeable batteries. If the heat emission/discharge/dissipation is not sufficiently performed, temperature deviations may occur between respective battery cells, such that the battery module may no longer generate a desired (or designed) amount of power. In addition, an increase of the internal temperature can lead to abnormal reactions occurring therein, and thus, charging and discharging performance of the rechargeable battery may deteriorate and the life-span of the rechargeable battery may be shortened.

Exothermic decomposition of cell components may lead to a so-called thermal runaway. Generally, thermal runaway describes a process that accelerates due to increased temperature, in turn releasing energy that further increases temperature. Thermal runaway occurs in situations when an increase in temperature changes the conditions in a way that causes a further increase in temperature, often leading to a destructive result. In rechargeable battery systems, thermal runaway is associated with strong exothermic reactions that are accelerated by temperature rise. During thermal runaway, the battery cell temperature rises incredibly fast and the energy stored is released very suddenly. In extreme cases, thermal runaway can cause battery cells to explode and start a fire. In minor cases, it can cause battery cells to be damaged beyond repair.

When a battery cell is heated above a critical temperature (e.g., above about 150° C.) the battery cell can transition into thermal runaway. Generally, temperatures outside of the safe region on either the low or high side may lead to irreversible damage to the battery cell and, therefore, may possibly trigger thermal runaway. Thermal runaway may also occur due to an internal or external short circuit of the battery cell or poor battery maintenance. For example, overcharging or rapid charging may lead to thermal runaway.

During thermal runaway, the failed battery cell may reach a temperature exceeding about 700° C. Further, large quantities of hot gas are ejected from inside of the failed battery cell through a venting opening in the cell housing into the battery pack. The main components of the vented gas are H₂, CO₂, CO, electrolyte vapor, and other hydrocarbons. The vented gas is therefore flammable and potentially toxic. The vented gas also causes gas-pressure to increase inside the battery pack. In the worst case, the high temperatures lead to the process (e.g., the thermal runaway) spreading to neighboring cells and a fire in the battery pack. At this stage, the fire is difficult to extinguish.

A conventional venting concept for a battery module is to let the venting gas stream discharged from the battery cell(s) expand into the battery housing and escape through a housing venting valve to the outside (e.g., to the environment surrounding the battery housing). This concept, however, causes the venting gas stream to heat up the components inside the battery housing, such as the other battery cells. Furthermore, particles from the venting gas stream may deposit onto the battery cells, which may lead to thermal propagation and may incite thermal runaway in adjacent battery cells. To protect the battery cells, a cover element may be provided covering at the venting side of the battery cells.

Such a cover element may have venting openings in the form of through-holes that are aligned with venting exits in the battery cells to let the venting gas stream pass through the cover element in case of a thermal runaway of one of the covered battery cells. After passing through the cover element, particles of the discharged venting gas stream may deposit onto the cover element. However, particles of the venting gas stream may pass through another venting opening of the cover element that is aligned with the venting exit of another one of the battery cells and may contact (or enter) the other battery cell. This may lead to thermal propagation of the other battery cell and, in the worst case, incite a thermal runaway in the other battery cell.

### SUMMARY

Embodiments of the present disclosure provide a battery system that more securely handles a thermal runaway of one or more of its battery cells.

The present disclosure is defined by the appended claims and their equivalents. The description that follows is subject to this limitation. Any disclosure lying outside the scope of the claims and their equivalents is intended for illustrative as well as comparative purposes.

According to one embodiment of the present disclosure, a battery system includes a plurality of battery cells, each of the battery cells having a venting exit for discharging a venting gas stream a venting side thereof, a first cover sheet having a first thickness covering the venting side of the battery cells to protect the battery cells from the venting gas stream discharged from an adjacent one of the battery cells, the first cover sheet having venting openings aligned with the venting exits of the battery cells for letting the discharged venting gas stream pass through the first cover sheet, and a second cover sheet having a second thickness arranged between the first cover sheet and the plurality of battery cells. The second cover sheet covering the venting exits of the battery cells and being configured to rupture at a section opposite the venting exits due to the discharged venting gas stream exiting the covered venting exit. The first thickness is larger than the second thickness.

According to an embodiment of the present disclosure, the first cover sheet and the second cover sheet may include a heat-resistant material.

According to an embodiment of the present disclosure, the first cover sheet and the second cover sheet may be mica sheets.

According to an embodiment of the present disclosure, the first cover sheet and the second cover sheet may be made of the same material.

According to an embodiment of the present disclosure, the first thickness may be 3-times to 20-times larger than the second thickness.

According to an embodiment of the present disclosure, the first thickness may be 5-times to 10-times larger than the second thickness.

According to an embodiment of the present disclosure, the first thickness may be at least 2 mm, or at least 3 mm, or at least 5 mm.

According to an embodiment of the present disclosure, the second thickness may be 0.2 mm or less, or 0.15 mm or less, or 0.1 mm or less.

According to an embodiment of the present disclosure, the second cover sheet may be directly on the battery cells.

According to an embodiment of the present disclosure, the second cover sheet may be adhered to the battery cells.

Another embodiment of the present disclosure provides a vehicle including a battery system as described above.

Further aspects and features of the present disclosure can be learned from the dependent claims and/or the following description.

### BRIEF DESCRIPTION OF THE DRAWINGS

Aspects and features of the present disclosure will become apparent to those of ordinary skill in the art by describing, in detail, embodiments thereof with reference to the attached drawings, in which:

FIG. 1 is a schematic cross-sectional view of a battery system according to an embodiment of the disclosure.

FIG. 2 is a perspective view of a part of the battery system shown in FIG. 1.

### DETAILED DESCRIPTION

Reference will now be made, in detail, to embodiments, examples of which are illustrated in the accompanying drawings. Aspects and features of the present disclosure, and implementation methods thereof, will be described with reference to the accompanying drawings. The present disclosure, however, may be embodied in various different forms and should not be construed as being limited to the embodiments illustrated herein. Rather, these embodiments are provided as examples so that this disclosure will be thorough and complete and will fully convey the aspects and features of the present disclosure to those skilled in the art.

Accordingly, processes, elements, and techniques that are not considered necessary for those having ordinary skill in the art to have a complete understanding of the aspects and features of the present disclosure may not be described or may be only briefly described. It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. For example, the expression “at least one of a, b, or c” indicates only a, only b, only c, both a and b, both a and c, both b and c, all of a, b, and c, or variations thereof. As used herein, the terms “use,” “using,” and “used” may be considered synonymous with the terms “utilize,” “utilizing,” and “utilized,” respectively.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

As used herein, the term “substantially,” “about,” and similar terms are used as terms of approximation and not as terms of degree, and are intended to account for the inherent deviations in measured or calculated values that would be recognized by those of ordinary skill in the art. Further, if the term “substantially” is used in combination with a feature that could be expressed using a numeric value, the term “substantially” denotes a range of +/−5% of the value centered on the value.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

According to one embodiment of the present disclosure, a battery system includes a plurality of battery cells. The battery cells may be accommodated inside a battery housing of the battery system. The battery cells may be arranged, or stacked, along a stacking direction to form one or more cell stacks. The battery cells may be interconnected via an electrical connector, for example, busbars, contacting respective electrode terminals of the battery cells to form one or more battery modules/battery packs. The battery cells may be arranged to form one or more battery packs. In a battery pack, the battery cells may be electrically interconnected, for example, in series and/or in parallel. Multiple battery packs may form a battery module. The battery cells may be, for example, prismatic or cylindrical cells.

Each of the battery cells has a venting exit at a venting side of the battery cell, which may be a terminal side of the battery cells at where the electrode terminals of the battery cells are disposed. Each venting exit is configured to allow for a venting gas stream to be discharged from the respective battery cell during a thermal runaway of the corresponding battery cell. Venting valves may be provided at (or in) the venting exits, which may open (e.g., burst or rupture) upon a reference pressure (e.g., a predefined pressure) being exceeded.

The battery system further includes a first cover sheet having a first thickness. The first cover sheet is disposed to cover the venting sides of the plurality of battery cells. In some embodiments, the first cover sheet covers all of the battery cells of the plurality of battery cells (e.g., the first cover sheet extends over the venting sides of all of the battery cells of the plurality of battery cells). The venting side of the battery cells may be a top side of the battery cells. The first cover sheet may, for example, cover the top side of the battery cells and, thus, may form a first top cover sheet. The top side of the battery cells is a side of the battery cells that faces upwardly in an intended use position of the battery system (e.g., in an installation position of the battery system inside an electric vehicle).

The first cover sheet covers the battery cells to protect the covered battery cells from venting products of the venting gas stream that may be discharged by one or more of the battery cells during a thermal runaway. For example, the first cover sheet may entirely cover the venting sides (e.g., the entire top side) of the battery cells except for the venting exits. The first cover sheet has a venting opening aligned with each venting exit of the battery cells. The first cover sheet has venting openings in the form of through-holes, and the venting openings are each aligned with one of the venting exits of the battery cells so that the venting gas stream exiting one of the battery cells via its venting exit may pass through the corresponding venting opening and, thus, through the first cover sheet. The first cover sheet may be a heat-resistant cover sheet such that it may withstand the temperature of the venting gas stream. Particles from the venting gas stream may deposit onto the first cover sheet without damaging it. The first cover sheet may prevent thermal propagation from the venting gas stream to the battery cells.

The battery system further includes a second cover sheet having a second thickness. The second cover sheet is disposed between the first cover sheet and the venting sides of the plurality of battery cells. The second cover sheet may be disposed directly on the venting sides of the battery cells (e.g., may be adhered or sealed to the venting sides of the battery cells). In some embodiments, the second cover sheet covers all of the battery cells of the plurality of battery cells (e.g., the second cover sheet extends over the venting sides of all of the battery cells of the plurality of battery cells). The second cover sheet also covers the venting exits of the battery cells. In other words, the second cover sheet extends over the venting sides (e.g., the top side) of the battery cells including the venting exits. The second cover sheet may form a second top cover sheet. The second cover sheet may entirely cover the venting sides (e.g., the entire top side) of the battery cells including the venting exits. That is, while the first cover sheet does not cover the venting exits of the battery cells, the second cover sheet does cover the venting exits.

The second cover sheet is configured to rupture (e.g., to burst or break) at sections opposite (e.g., aligned with) the venting exits due to the pressure of the discharged venting gas stream exiting the covered venting exit. In other words, the second cover sheet is configured such that it cannot withstand the pressure exerted onto the second cover sheet by a venting gas stream exiting one of the covered battery cells. Thus, when a battery cell from among the plurality of battery cells undergoes thermal runaway, a hot venting gas stream exits the affected battery cell at its venting exit and ruptures the second cover sheet. The second cover sheet may be configured to burst based on its material and/or thickness. For example, the second cover sheet may have a thickness that is sufficiently small such that the second cover sheet ruptures when the venting gas pressure is exerted upon it but that is large enough that the second cover sheet may withstand any particles deposited onto the second cover sheet from the other side.

The first cover sheet, however, shall withstand these pressures. Thus, the first thickness is larger than the second thickness. In other words, the second cover sheet has a smaller thickness than the first cover sheet. The second cover sheet may have uniform thickness. That is, the second cover sheet may have the same thickness in the sections opposite the venting exits as at the surrounding sections or any other sections than the sections opposite the venting exits. The sections of the second cover sheet opposite the venting exits may be parts (or portions) of the uniform sheet that are aligned with the venting exits and venting openings. The second cover sheet may be a heat-resistant cover sheet such that it may withstand particles from the venting gas stream that deposit onto the second cover sheet without being damaged. Also, the second cover sheet covering the venting exits may prevent any outside contamination, such as moisture or other particles, from entering the battery cells through their venting exits during normal operation.

The venting gas stream discharged by one of the battery cells of the plurality of batter cells undergoing thermal runaway may leave (e.g., may exit) the venting exit of the affected battery cell, rupture the corresponding section of the second cover sheet opposite the venting exit, pass through the second cover sheet, enter and pass through the venting opening of the first cover sheet and, thus, pass through the first cover sheet. The venting gas stream ejected in such a manner is kept away from the other battery cells of the battery system by the first and second cover sheets.

For example, the venting gas stream may come into contact with an outer side of the first cover sheet and, at the venting openings, with the underlying second cover sheet (e.g., with the sections of the underlying second cover sheet opposite the venting exits and facing the venting openings). However, the venting gas stream, even when passing through another venting opening, cannot enter another battery cell because the venting exit of that battery cell is covered and sealed by the second cover sheet. For example, particles form the venting gas stream may deposit onto the first cover sheet and, at the venting openings of the first cover sheet, onto the sections of the second cover sheet beneath the venting openings but may not reach the underlying battery cells. The ruptured section of the second cover sheet will rupture only at a high pressure that occurs during thermal runaway of that battery cell the venting exit is aligned with. Such a pressure may be built up due to the second cover sheet sealing the venting exit.

The two cover sheets combine the protective advantages of a cover having a high thickness combined with a cover having a low thickness in sections corresponding to the venting openings. The two cover sheets provide a combined cell cover that, on one hand, is stable enough to protect the battery cells and, on the other hand, is brittle enough to enable venting. Placing the thinner second cover sheet on the thicker first cover sheet would risk that the thinner second cover sheet bending outwardly so that venting gas might possibly flow between the cover sheets towards the adjacent battery cells, but arranging the thinner second cover sheet below the thicker first cover sheet prevents this. Also, arranging the thinner second cover sheet below the thicker first cover sheet helps rupturing of the thinner second cover sheet as it can lean on (e.g., be guided by) the edge of the venting opening of the thicker first cover sheet. That is, the second cover sheet may be held in place by the first cover sheet during rupturing.

According to an embodiment, the first cover sheet and/or the second cover sheet are mica sheets. In other words, the first cover sheet and/or the second cover sheet may include mica silicate minerals. Such mica sheets are heat-resistant. Also, such mica material may be a suitable material for the second cover sheet because, in a suitable thickness range, the second cover sheet being a mica sheet or including mica allows for the second cover sheet to rupture as intended while being able to withstand any particles deposited onto the second cover sheet.

According to an embodiment, the first cover sheet and the second cover sheet are made of the same material. For example, the first cover sheet and the second cover sheet may be mica sheets. Choosing the same material, such as mica, for both the first and the second cover sheet may provide the advantages of providing protection and allowing venting in a constructively simple manner. As described, mica sheets are heat-resistant and, thus, well suited for use as first and second cover sheets.

According to an embodiment, the first thickness is about 3-times to about 20-times larger than the second thickness. According to an embodiment, the first thickness is about 5-times to about 10-times larger than the second thickness. That is, the first cover sheet may be about 3-times to about 20-times thicker, or about 5-times to about 10-times thicker, than the second cover sheet. A thickness difference between the cover sheets in such ranges may support rupturing of the thinner second cover sheet because it may be held sufficiently in place so that it can lean on the edge of the venting opening of the thicker first cover sheet when exposed to the high pressure of the venting gas stream.

According to an embodiment, the first thickness is at least about 2 mm, or at least about 3 mm, or at least about 5 mm. In other words, the first cover sheet may have a thickness of at least about 2 mm, or at least about 3 mm, or at least about 5 mm. The first cover sheet may have a uniform thickness and, thus, may have a thickness of at least about 2 mm, or at least about 3 mm, or at least about 5 mm over its entire extension. The first cover sheet having such a thickness may provide the intended protection from the venting gases and particles and may support rupturing of the thinner second cover sheet.

According to an embodiment, the second thickness is about 0.2 mm or less, or about 0.15 mm or less, or about 0.1 mm or less. In other words, the second cover sheet may have a thickness of about 0.2 mm or less, or about 0.15 mm or less, or about 0.1 mm or less. The first cover sheet may have a uniform thickness and, thus, may have a thickness of at least about 2 mm, or at least about 3 mm, or at least about 5 mm over its entire extension. The second cover sheet having such a thickness may ensure the intended rupturing of the second cover sheet while reliably keeping the venting gases and particles discharged by other battery cells from contacting adjacent battery cells.

According to an embodiment, the second cover sheet is disposed directly on the battery cells at their venting sides. In other words, the second cover sheet may be arranged directly on the battery cells without any intervening sheets or elements. For example, according to an embodiment, the second cover sheet is adhered and, thus, sealed to the battery cells. The second cover sheet may be, for example, glued to the battery cells. Also, the second cover sheet may be pressed onto the battery cells by the first cover sheet. The second cover sheet being disposed directly on the battery cells and/or adhered and/or pressed onto the battery cells may provide for a suitable (or sufficient) build up in pressure during thermal runaway such that the section of the second cover sheet opposite the venting exit of the battery cells affected by the thermal runaway may rupture as intended.

Embodiments of the present disclosure also provide an electric vehicle including a battery system as described herein, for example, as a traction battery.

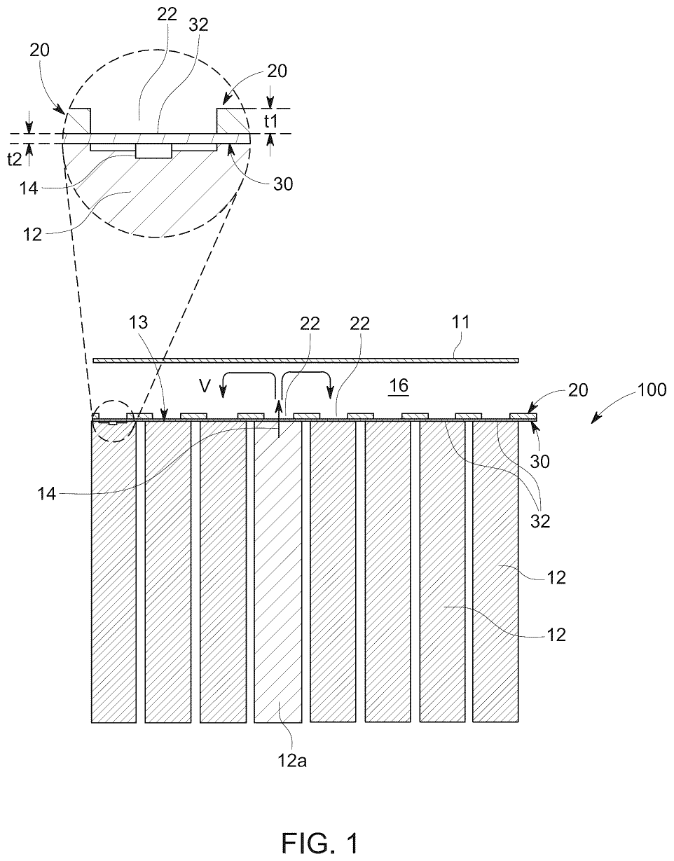

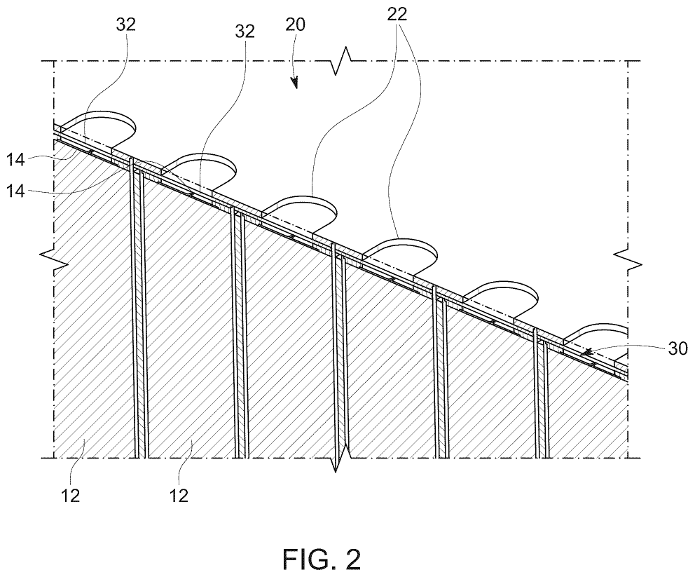

FIGS. 1 and 2 schematically illustrate a battery system 100 according to an embodiment of the present disclosure.

The battery system 100 includes a plurality of battery cells 12 arranged to form a cell stack. Each of the battery cells 12 includes, at a venting side thereof, a venting exit 14 for discharging a venting gas stream in case of (e.g., in the event of) a thermal runaway. Each of the venting exits 14 may include a venting valve. The venting sides of the battery cells 12 may form (or may be) a top side 13 of the battery cells 12. The plurality of battery cells 12 may be arranged inside a battery housing of which only a wall member 11 is shown. The wall member 11 is arranged opposite (e.g., is above and faces) the top side 13 of the battery cells and delimits (e.g., defines or forms) a venting channel 16.

A heat-resistant first cover sheet 20 of the battery system 100 is disposed on the top side 13 of the battery cells 12. The first cover sheet 20 may be a mica sheet. The first cover sheet 20 may have a uniform first thickness t1 of, for example, about 2 mm. The first cover sheet 20 has venting openings 22 in the form of through-holes, and the venting openings 22 are aligned with the venting exits 14 of the battery cells 12 to allow the venting gas stream discharged from the venting exits 14 to pass through the first cover sheet 20. The first cover sheet 20 may completely cover the plurality of battery cells 12 at their top side 13 aside from (or except where) the venting exits 14 where venting openings 22 are arranged.

The battery system 100 further includes a heat-resistant second cover sheet 30 disposed between the first cover sheet 20 and the plurality of battery cells 12. The second cover sheet 30 may be a mica sheet. The second cover sheet 30 may have a uniform second thickness t2 of, for example, about 0.2 mm. The second cover sheet 30 may completely cover the plurality of battery cells 12 at their top side 13 including the venting exits 14. Thus, the second cover sheet 30 may be (or may form) one continuous layer. The second cover sheet 30 may be adhered, for example, glued, to the top side 13 of the battery cells 12 and/or may be pressed against the top side 13 of the battery cells 12. The second cover sheet 30, thus, seals the venting exits 14 with respect to the venting channel 16. The second cover sheet 30 is configured to rupture at a section 32 opposite (e.g., aligned with) the venting exits 14 due to the pressure of the discharged venting gas stream exiting the covered venting exits 14 in case of a thermal runaway.

In FIG. 1, a battery cell 12a is undergoing (or experiencing) thermal runaway from among the plurality of battery cells 12 and, thus, discharges a venting gas stream V from its venting exit 14. This results in pressure build-up beneath the second cover sheet 30 and, consequently, to a section of the second cover sheet 30 opposite (e.g., aligned with) the venting exit 14 rupturing. Accordingly, the sealing provided by the second cover sheet 30 is broken (or ruptured) above the affected battery cell 12, and the venting gas stream V may pass through the second cover sheet 30. As indicated by the arrows in FIG. 1, the venting gas stream V then passes through the corresponding venting opening 22 in the first cover sheet 20 and, thus, through the first cover sheet 20 and into the venting channel 16. The venting gas stream V may then be deflected by the opposite wall member 11 and may expand (e.g., may flow) along the venting channel 16.

During this process, the venting gas stream V may flow into the venting openings 22 aligned with other ones of the battery cells 12 but is stopped by the second cover sheet 30. Thus, the second cover sheet 30 prevents the venting gas stream V from reaching other battery cells 12 and, thereby, prevents thermal propagation of the thermal runaway to adjacent battery cells 12.

The first cover sheet 20 protects the top side 13 of the battery cells 12 from venting products of the venting gas stream and may hold (or secure) the second cover sheet 30 in place during the rupturing. For example, placing the thinner second cover sheet 30 below the thicker first cover sheet 20 helps (or directs or controls) rupturing of the thinner second cover sheet 30 because it can lean on the edge of the venting opening 22 of the thicker first cover sheet 20. The thicker first cover sheet 20 prevents the thinner second cover sheet 30 from being bent outwardly by the venting gas stream V, which may otherwise result in venting gas flowing between the first cover sheet 20 and second cover sheet 30 towards the adjacent battery cells 12. The first cover sheet 20 has a first thickness t1 of, for example, about 2.0 mm, the second cover sheet 30 has a second thickness t2 of, for example, about 0.2 mm, and both the first cover sheet 20 and the second cover sheet 30 may include (or may be made of) mica provides sufficient protection of the battery cells 12 from the venting gas stream V while allowing for the second cover sheet 30 to be ruptured by the venting gas pressure.

### SOME REFERENCE SYMBOLS

11 wall member of battery housing
12 battery cells
12a battery cell undergoing thermal runaway
13 top side of battery cells
14 venting exits
16 venting channel
20 first cover sheet
22 venting openings
30 second cover sheet
32 sections of second cover sheet opposite the venting exits
100 battery system
V venting gas stream
t1 first thickness
t2 second thickness

What is claimed is:

1. A battery system comprising:
a plurality of battery cells, each of the battery cells having a venting exit for discharging a venting gas stream at a venting side thereof;
a first cover sheet having a first thickness covering the venting side of the battery cells to protect ones of the battery cells from the venting gas stream discharged from an adjacent one of the battery cells, the first cover sheet having venting openings aligned with the venting exits of the battery cells for letting the discharged venting gas stream pass through the first cover sheet; and
a second cover sheet having a second thickness arranged between the first cover sheet and the plurality of battery cells, the second cover sheet covering the venting exits of the battery cells, the second cover sheet being configured to rupture at a section opposite the venting exits due to the discharged venting gas stream exiting the covered venting exit,
wherein the first thickness is larger than the second thickness.

2. The battery system as claimed in claim 1, wherein the first cover sheet and the second cover sheet comprise a heat-resistant material.

3. The battery system as claimed in claim 1, wherein the first cover sheet and the second cover sheet are made of the same material.

4. The battery system as claimed in claim 1, wherein the first cover sheet and the second cover sheet are mica sheets.

5. The battery system as claimed in claim 1, wherein the first thickness is 3-times to 20-times larger than the second thickness.

6. The battery system as claimed in claim 5, wherein the first thickness is 5-times to 10-times larger than the second thickness.

7. The battery system as claimed in claim 1, wherein the first thickness is at least 2 mm.

8. The battery system as claimed in claim 1, wherein the second thickness is 0.2 mm or less.

9. The battery system as claimed in claim 1, wherein the second cover sheet is directly on the battery cells.

10. The battery system as claimed in claim 1, wherein the second cover sheet is adhered to the battery cells.

11. An electric vehicle comprising the battery system as claimed in claim 1.
